(19) United States
(12) Patent Application Publication
(10) Pub. No.: US 2007/0013973 A1
(43) Pub. Date: Jan. 18, 2007

(54) Scanner and scanner control method

(75) Inventors: Yasuhiko Yoshihisa, Nagano-Ken (JP); Hitoshi Igarashi, Nagano-Ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/487,007

(22) Filed: Jul. 14, 2006

(30) Foreign Application Priority Data
Jul. 15, 2005 (JP) 2005-206913
Jul. 28, 2005 (JP) 2005-218204

(51) Int. Cl. H04N 1/04

(52) U.S. Cl. 358/474; 358/486

(57) ABSTRACT

A scanner provided with an image sensor that integrates reflected light that occurs due to reflections from a scan position, and then converts into specific image data the reflected light that has been integrated, and outputs this image data, wherein a plurality of segments, in the scan direction are provided for an object to be scanned by moving a scan position in the scan direction in the object to be scanned, where an image sensor is controlled so that, when the scan position passes over each of the segments of the object to be scanned, because of the motion of a carriage, the image sensor is controlled so as to start integrating the reflected light that occurs at the scan position with the timing with which the scan position enters into each of the segments of the object to be scanned, and thereafter, the image sensor is caused to stop integrating the reflected light after a specific amount of time has elapsed, where the reflected light that has been integrated is converted by the image sensor and outputted as image data for the segment, where the specific time interval is uniform for all segments. This prevents chromatic non-uniformities between the line image data.

### BACKGROUND OF THE INVENTION

1. Field of the Invention

The present invention relates to technologies for integrating reflected light, from a scan position, in an image sensor under specific conditions in a scanner.

2. Description of the Related Art

Conventionally there have been scanners that generate image data by scanning specific objects to be scanned (hereinafter termed “manuscripts”). (See Japanese Patent Laid-Open Gazette No. 2004-282561.) The carriage in such a scanner is provided with a light source, and light is emitted from the light source. The light that is emitted from the light source is incident on the manuscript to form an illuminated region (hereinafter termed the “scan position”). Light is reflected from the scan position, where this reflected light is incident on an image sensor through, for example, a specific mirror. This image sensor integrates the reflected light over a prescribed time interval, and converts the integrated reflected light into an electric signal. This process generates image data corresponding to the portion of the manuscript over which the scan position travels during the aforementioned prescribed time interval. The carriage is conveyed in the scan direction by a carriage conveyance mechanism, using a specific motor as the actuator, and the scan position moves together with the carriage.

However, when the resolution in the scan direction is specified by the user, then, in the scanner, a plurality of lines will be set for the region to be scanned in the manuscript, depending on a density that corresponds to the specified resolution. Each of these lines is in the form of a band, and are set so as to be equal to each other in the scan direction. When the scanner conveys the carriage in the scan direction, the scan position moves across each line accordingly.

At this time, when the scan position arrives at the starting point for each line, the scanner causes the image sensor to begin integrating the reflected light, and when the scan position reaches the end point of the line, the scanner causes the image sensor to stop integrating the reflected light, and the image data for that line (hereinafter termed the “line image data”) is generated in the image sensor. In this case, the scanner drives the aforementioned motor to convey the carriage in the scan direction so that the time interval for the scan position to pass over each line will be a constant time interval R, which can be set in advance.

However, in a scanner such as described above, when the aforementioned motor is driven so as to cause the time interval for the scan position to pass over each line to be the aforementioned constant time interval R in each of the lines, variability in the rotation of the motor (rotational variability), and the like may cause the time interval over which the scan position passes over each line to be either longer or shorter than the aforementioned constant time interval R. In such a case, the aforementioned prescribed time interval for the image sensor to integrate the reflected light in each line will be longer or shorter than the aforementioned time interval R, and as a result there is a problem in that there will be chromatic non-uniformities from one line to the next in the line image data generated for each line.

The object of the invention is thus to eliminate the drawbacks of the prior art technique and to provide a technology for controlling the chromatic non-uniformities between line image data in the scanner.

### SUMMARY OF THE INVENTION

In order to attain at least part of the above and the other related objects, the present invention is directed to a first scanner for generating image data by scanning a specific object to be scanned, comprising:

a motor;

a carriage that is driven by the motor to move, in the scan direction, a scan position in the object to be scanned;

an image sensor that integrates reflected light that occurs as a reflection from the scan position, and converts the integrated reflected light into specific image data, and outputs the image data;

an segment setting unit for setting a plurality of segments in the scanning direction in the object to be scanned; and

an image sensor control unit for controlling the image sensor, wherein

the image sensor control unit causes the image sensor to start the integrating of the reflected light that occurs from the scan position with the timing with which the scan position enters into the segment in each of the segments of the object to be scanned, when the scan position passes over each of the segments of the object to be scanned through the carriage moving, and thereafter, the image sensor control unit causes the image sensor to stop the integrating of the reflected light after a prescribed time interval has elapsed, and causes the integrated the reflected light to be converted by the image sensor and outputted as image data for the segment, along with controlling the image sensor so that the specific time interval is the same time interval in each segment.

Given the aforementioned structure, in each segment of the object being scanned, the time interval over which the reflected light will be integrated in the image sensor will be uniform, thus making it possible to prevent chromatic non-uniformities between the image data of the individual segments of the object being scanned, which image data express the integrated reflected light.

The scanner described above may be provided with a motor control unit for controlling the motor so that the speed of movement of the carriage is slower than the speed when the carriage is moved over the specific time interval over a distance corresponding to the segment.

Such a structure makes it possible to cause the speed of movement of the carriage to be slower than the speed of movement of the case wherein the carriage moves a distance corresponding to the segment of the object to be scanned over the aforementioned prescribed time interval, even when rotational variability in the motor, or the like, causes the speed of movement of the carriage (the scan position) to be faster than the speed of movement that has been set. Consequently, the time interval over which the scan position moves over a segment, for each segment in the object being scanned, can be controlled to be no more than the aforementioned prescribed time interval. In other words, in each segment it is possible to control the time over which the image sensor integrates the reflected light so as to be no more than the prescribed time. The result is that it is possible to prevent the occurrence of chromatic non-uniformities between the image data of the individual segments of the object being scanned.

The present invention is also directed to a second scanner for generating image data by scanning a specific object to be scanned, comprising:

a motor;

a carriage that is driven by the motor to move, in the scan direction, a scan position in the object to be scanned;

an image sensor that integrates the reflected light that is produced by reflecting from the scan position, and converts the integrated reflected light into specific image data, and outputs the image data;

an image sensor control unit; and

a motor control unit, wherein

the image sensor control unit causes the image sensor to start the integrating of the reflected light that occurs at the scan position with the timing with which the scan position enters the start point of a segment, in each of the segments of the object to be scanned, when the scan position passes over each of the individual segments, due to the motion of the carriage, in the scan direction relative to the object to be scanned, and, thereafter, the image sensor control unit causes the image sensor to stop the integrating of the reflected light when a specific time interval, established in advance, has elapsed after the timing, after which the reflected light that has been integrated is converted by the image sensor and outputted as image data for the segment; wherein

the motor control unit causes the scan position to continue moving in the same way by causing the motor to continue moving the carriage in the same way when the scan position has not yet reached the end point of the segment even when the specific time interval has elapsed from the timing at which the scan position entered into the start point of the segment; and wherein

the motor control unit stops the motion of the scan position, through stopping the driving of the carriage by controlling the motor when the scan position has reached the end point of the segment even though the specific time interval has not yet elapsed after the timing, where, thereafter, the motor control unit causes the carriage to be driven, by controlling the motor, to start the movement of the scan position when the specific time interval has elapsed after the timing.

The scanner structured as described above makes it possible to cause the time intervals over which the reflected light is integrates in the image sensor to be constant, even when there is the occurrence of rotational error (rotational variability) in the motor in each of the segments of the object being scanned, making it possible to prevent the occurrence of chromatic non-uniformities between image data in the individual segments of the object being scanned, which represent the integrated reflected light.

In the scanner, the specific time interval may be the maximum integrating time interval in order to integrate the reflected light without saturating the integrating of the reflected light.

With the structure described above there is no saturation of the integrated reflected light, thus making it possible to prevent chromatic non-uniformities between the image data for each segment, which express the integrated reflected light, and possible to generate the image data for each segment with excellent precision.

The scanner, maybe provided with an image data generating unit for generating the image data that expresses the object to be scanned, based on each image data in each of the segments of the object to be scanned. Doing so makes it possible to generate image data for the object being scanned.

Moreover, the aforementioned motor may be a DC motor that is driven by direct current.

Not that the present invention is not limited to the form of a device invention, such as the aforementioned scanners, but instead may be expressed in the form of a process invention, such as a method for controlling a scanner. Furthermore, the present invention may be expressed in a variety of forms such as in the form of a computer program for structuring these processes or devices, in the form of a recorded medium on which such a computer program is recorded, in the form of data signals that are implemented within carrier waves and that include the aforementioned computer program, and so forth.

Moreover, when the present invention is in the form of a computer program, a recording medium on which the computer program is recorded, or the like, the program may be structured as an entire program for controlling the operations of the device as described above, or may comprise only the parts that achieve the functions of the present invention.

### BRIEF DESCRIPTION OF THE DRAWINGS

FIG. 1 is a perspective view showing an outside view of a scanner 100 as a first embodiment according to the present invention.

FIG. 2 is a figure for explaining briefly the structure within a scanner main unit 110 in a scanner 100 according to the embodiment.

FIG. 3 is an oblique view for explaining the structures and functions of a carriage 200 in the embodiment.

FIG. 4 is an explanatory diagram illustrating schematically the structure of a control circuit 500 according to the embodiment.

FIG. 5 is a flow chart illustrating the process of reading a manuscript, performed by the scanner 100 in the first embodiment.

FIG. 6 is a view of the manuscript from the carriage 200 in the embodiment.

FIG. 7 is a flow chart illustrating the scanning control process in the first embodiment.

FIG. 8 is a figure illustrating the state wherein an image sensor control unit 520 controls an image sensor 220 according to changes in the time interval at the position of the scan position in the manuscript.

FIG. 9 is a flow chart illustrating the process for reading in a manuscript, performed by the scanner 100 in a second embodiment.

FIG. 10 is a flow chart illustrating the scanning control process in the second embodiment.

FIG. 11 is a diagram illustrating the situation wherein a DC motor control unit 540 and an image sensor control unit 520 control a DC motor 700 and an image sensor 220, respectively, according to the change in time interval at the position of the scan position in the manuscript.

FIG. 12 is a figure illustrating the situation when the scan position, shown in FIG. 6, arrives at the scan start position in the second line.

### DESCRIPTION OF THE PREFERRED EMBODIMENTS

A form of embodiment according to the present invention will be described below based on examples of embodiment.

### A. First Embodiment

A1. Structure of the Scanner

A2. Read-in Process

### B. Second Embodiment

B1. Structure of the Scanner

B2. Read-in Process

### C. Modified Examples

### A. First Embodiment

A1. Structure of the Scanner

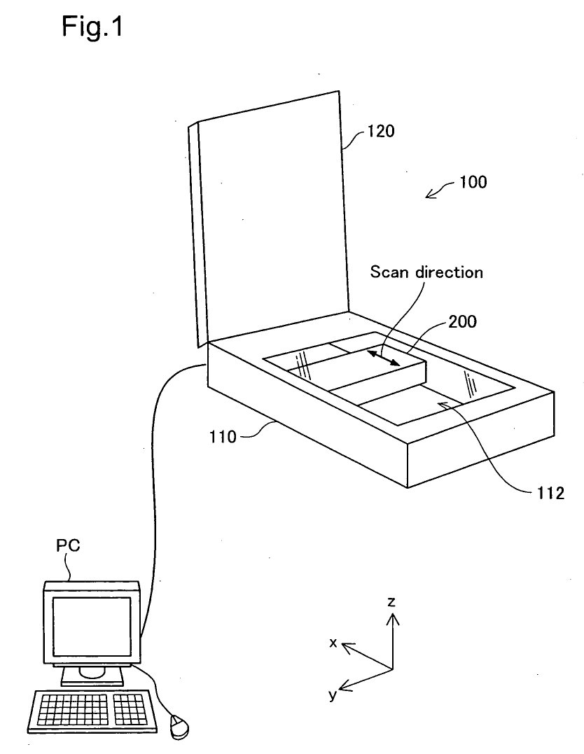

FIG. 1 is a oblique view showing the outside of a scanner 100 as a first embodiment according to the present invention. The scanner 100 is a device that reads in a manuscript to generate image data. The scanner main unit 110 is provided with a manuscript cover 120. The scanner 100 is connected to a personal computer PC (hereinafter termed simple “the PC”). A manuscript stage 112, for the placement of the manuscript, is provided on the top surface of the scanner main unit 110. Moreover, the scanner main unit 110 is provided with a variety of internal mechanisms, described below, such as the carriage 200. The carriage 200 is structured so as to move inside the scanner main unit 110 in the direction of the arrow shown in FIG. 1 (hereinafter termed the “scan direction”).

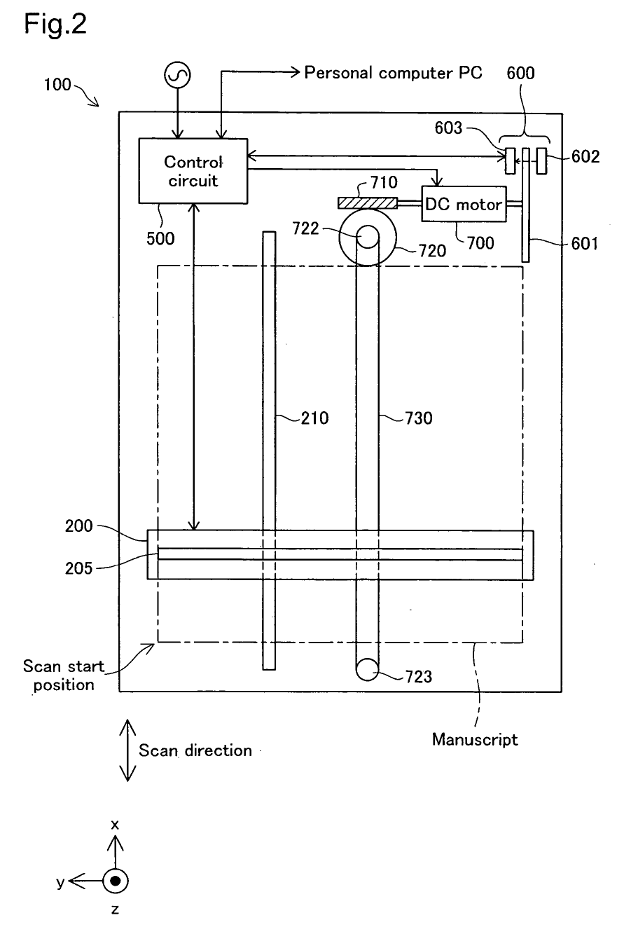

FIG. 2 is a figure for explaining briefly the structure within the scanner main unit 110 in the scanner 100 according to the present embodiment. As is shown in FIG. 2, the scanner 100 is provided, within the scanner main unit 110, with primarily a control circuit 500, a carriage 200 that is provided with the image sensor 220, described below, a carriage conveyance mechanism for conveying the carriage in the scan direction, and an encoder 600.

The carriage conveyance mechanism is provided with a DC motor 700, which is a direct current motor, a worm gear 710 which is connected to the power axel of the DC motor 700, a flat gear 720 that mates with the worm gear 710 to rotate at a specific reduction ratio, a pulley 722 that is connected to the flat gear 720, a pulley 723, a timing belt 730 that is installed between the pulley 722 and the pulley 723 and having one part thereof connected to the carriage 200, and a guide rail 210 for conveying the carriage 200 in the scan direction. The carriage 200 is conveyed along the guide rail 210 in the scan direction when the DC motor 700 is driven so that the timing belt 730 is driven. Note that in the below, the distance traveled by the carriage 200 when the DC motor 700 rotates once is defined as the travel distance M. The DC motor 700 corresponds to the “motor” in the claims.

The encoder 600 is a rotary encoder, and is provided with a disk 601 that is attached to the power axel of the DC motor 700, and a light-emitting diode 602 and a photodiode 603, disposed on either side of the disk 601.

The disk 601 is provided with slits (not shown) at prescribed intervals around the periphery thereof, where the photodiode 603 can receive through the slits the light emitted by the light-emitting diode 602. Consequently, as the disk 601 rotates along with the rotation of the DC motor 700, the photodiode 603 receives, at the slit parts, light emitted by the light-emitting diode 602, and does not receive light at parts other than the slit parts. The result is that the photodiode 603 generates a number of pulses (hereinafter termed the “encoder pulses”) according to the number of rotations of the DC motor 700, where the encoder 600 outputs this number of pulses to the outside.

Note that, although not shown, there are two sets of these light-emitting diodes 602 and photodiodes 603, disposed so that the encoder pulses from the respective photodiodes 603 are outputted with a phase difference of π/2. Consequently, the encoder control unit 530, described below, can detect the direction of rotation of the DC motor 700 from the change in phase of the encoder pulses.

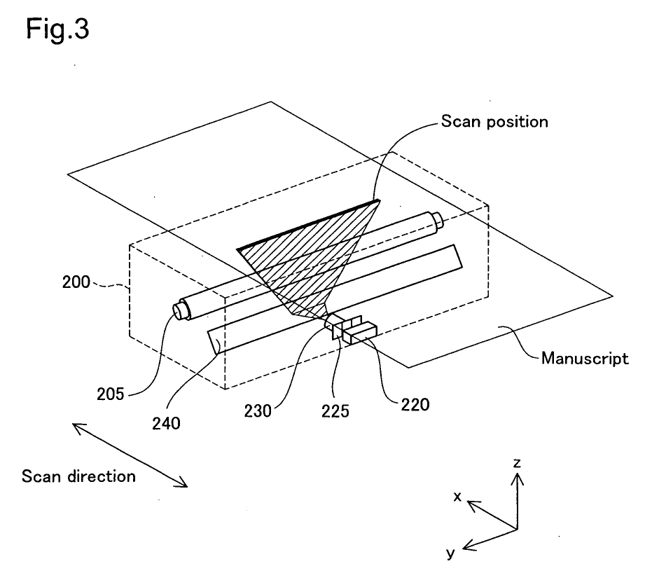

FIG. 3 is an oblique view for describing the structure and function of the carriage 200 in the present embodiment. As is shown in FIG. 3, the scanner 100 in the present embodiment uses the so-called optical scaling method as the method of reading in the manuscript. The carriage 200 is provided with an image sensor 220, an RGB filter 225, a lens 230, a mirror 240, and an illumination light 205. A CCD or CMOS photographic element, or the like, may be used as the image sensor 220. Note that in FIG. 3, for ease in explanation, only the carriage 200 and the manuscript are shown, and the other structural elements of the scanner 100 are omitted.

The carriage 200 emits light from the illumination light 205. The light that is emitted from the illumination light 205 is reflected on the manuscript to form an illuminated region. Hereinafter, this illuminated region will be termed “the scan position” (FIG. 3). Reflected light is produced at the scan position, where this reflective light is reflected again from a mirror 240, and travels through the RGB filter 225 and a lens 230 to be incident on the image sensor 220. The image sensor 220 integrates the incident reflected light, based on an instruction from the image sensor control unit 520 of the control circuit 500, described below (i.e., a start integrating signal, described below, is inputted), and when there is an instruction from the image sensor control unit 520 (that is, when the stop integrating signal, described below, is inputted), then the integrating of the reflected light is terminated, and after the reflected light that has been integrated is converted into an electrical signal, this signal is outputted to the image sensor control unit 520. The carriage 200 is conveyed in the scan direction by a carriage conveyance mechanism, where the scan position moves with the carriage 200.

Note that in the below the interval between the start of reflected light integration and the end of reflected light integration by the image sensor 220 is termed the “integrating time interval.” In this integrating time interval the maximum integrating time interval for integrating the reflected light without saturation by the reflected light that is integrated in the image sensor 220 is termed, in particular, the preferred integrating time interval T. Moreover, the electrical signals that are outputted from the image sensor 220 are converted into gradation levels by the image sensor control unit 520. These outputted electrical signals and gradation levels converted from the electrical signals both express the image data for the particular part in the manuscript, but, in the below, the gradation level, converted from the electrical signal, in particular, will be treated as the image data for the specific position in the manuscript. The explanation of the relationship with the specific position will be explained below.

In FIG. 3, an optical path to the incidence of the reflected light on the image sensor 220 was formed using the mirror 240 alone; however, the present embodiment is not limited to this case, but rather in addition to the mirror 240, a plurality of mirrors may be used to adjust the optical path length prior to the incidence of the reflected light on the image sensor 220, to form a desired optical path length.

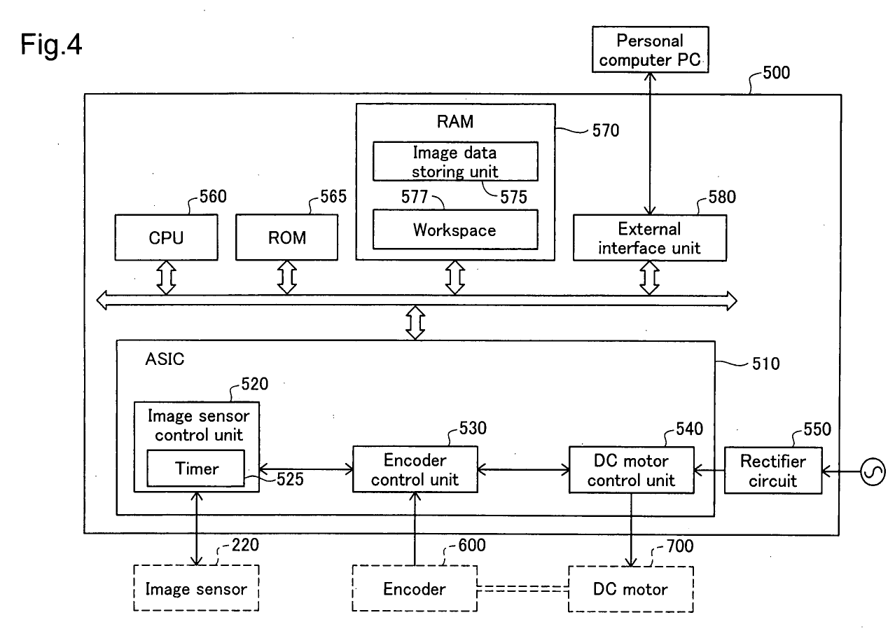

FIG. 4 is an explanatory diagram illustrating schematically the structure of a control circuit 500 in the present embodiment. As is shown in FIG. 4, the control circuit 500 is provided with, primarily, a CPU 560, a ROM 565, a RAM 570, an external interface part 580, a rectifying circuit that converts the supplied AC electric current into DC electric current, and an ASIC 510 as a specific integrated circuit.

The RAM 570 is provided with an work area 577 for performing, for example, the program start/end operations and the image data generating operations, and an image data storing unit 575 for storing the image data generated from the manuscript.

The CPU 560 performs a variety of control operations for controlling the entirety of the scanner 100 by executing, in the workspace 577, specific programs stored in the ROM 565. Moreover, the CPU 560 receives through an external interface part 580 resolution information, specified by the user and sent from the PC, that indicates the resolution (dpi) with which to read in the manuscript, scan region information that indicates the region to scan (hereinafter termed the “scan region”) on the manuscript, and so forth, and also sends this information to the ASIC 510. Note that the resolution information is information that specifies the resolution in the scan direction (the x direction) (hereinafter termed the “scan direction resolution P”) and information indicating the resolution in the y direction. The scan region information comprises information indicating the length in the scan direction (hereinafter termed the “scan direction length N”) and information indicating the scan region in the y direction.

The ASIC 510 is structured from a specific integrated circuit, and is provided with an image sensor control unit 520, an encoder control unit 530, and a DC motor control unit 540, and performs a reading process, described below.

The image sensor control unit 520 performs control so that the time interval over which the image sensor 220 integrates the reflected light will be the preferred integrating time T, and inputs, and converts into gradation levels, the electric signals outputted from the image sensor 220. Moreover, the image sensor control unit 520 generates the image data for the manuscript from the line image data for each line, as described below. This image sensor control unit 520 corresponds to the image sensor control unit and the image data generating unit in the claims.

Moreover, the image sensor control unit 520 is provided with a timer 525. The image sensor control unit 520 measures time using the timer 525.

The encoder control unit 530 detects encoder pulses outputted from the encoder 600, and detects the movement distance of the carriage 200 in the scan direction from the number of encoder pulses detected, the number of slits in the disk 601, and the aforementioned movement distance M. Moreover, the encoder control unit 530 detects the direction of rotation of the DC motor 700. Consequently, the encoder control unit 530 is able to detect the relative position of the carriage 200 relative to a specific position in the scan direction based on the direction of rotation of the DC motor 700 and the movement distance detected for the carriage 200 (based on the number of encoder pulses. This encoder control unit 530 corresponds to the “segment setting unit” in the claims.

The DC motor control unit 540 controls the speed of rotation of the DC motor 700 through controlling the voltage (the drive voltage) in addition to supplying to the DC motor 700 the DC power outputted from the rectifier circuit 550. Moreover, the DC motor control unit 540 controls this drive voltage through pulse width modulation (PWM) control. In other words, the DC motor control unit 540 not only turns the power control transistor (not shown) on and off with a specific switching interval (for example, 50 μS), but also changes the ON time interval proportion relative to the switching interval (that is, the duty ratio) depending on the driving voltage. In this way, the ON time is shortened and the driving voltage reduced by reducing the duty ratio, and the ON time is extended and the driving voltage is increased by increasing the duty ratio. This DC motor control unit 540 corresponds to the “motor control unit” in the claims.

A2. Read-in Process

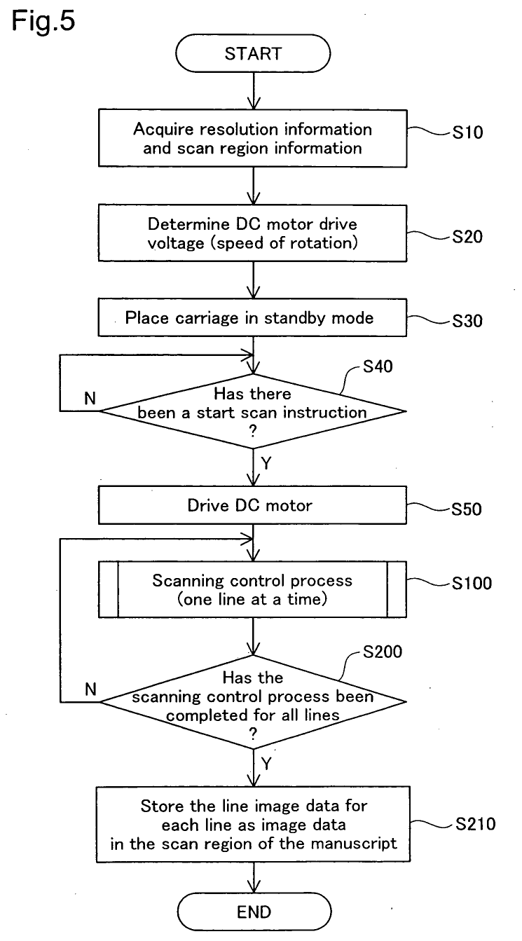

FIG. 5 is a flow chart showing the process for reading a manuscript, performed by the scanner 100 in the present embodiment. Given this, an explanation will be given of the reading process wherein the scanner 100 (the ASIC 510) reads the manuscript to generate the image data for the manuscript.

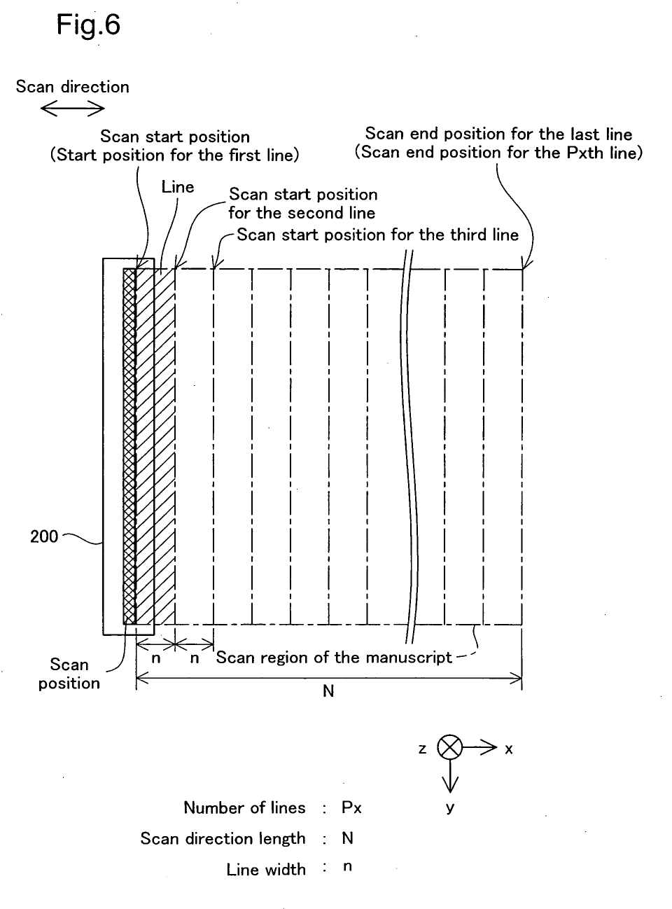

FIG. 6 is a view of the manuscript from the carriage 200 in the present embodiment. First the ASIC 510 acquires, from a CPU 560, the resolution information (the scan direction resolution information and the resolution information for the y direction) and the manuscript scan region information (scan direction length information and y direction range information), which was sent from the PC. The encoder control unit 530 sets a plurality of equal lines at a density that corresponds to scan direction resolution P in the scan region in the scan direction, as shown in FIG. 6. Each line width n (hereinafter referred to as “line width n”) is determined by the scan direction resolution P. Moreover, the number of lines Px is determined by the scan direction length N, which expresses the scan direction length information. Note that, for convenience in explanation, in FIG. 6 the line width n is actually shown as being larger than the size of the scan area.

The scanner 100 in the present embodiment generates manuscript image data detecting the line image data in each line of the lines that are traversed by the scan position, which is formed by the carriage 200 on the manuscript, and then combining together the line image data that has been detected.

Following this, the DC motor control unit 540 determines (sets) the driving voltage (speed of rotation) of the DC motor 700 (in Step S20). In other words, the DC motor control unit 540 calculates the movement speed W when it is assumed that the carriage 200 moves by a line width n in the scan direction over the preferred integration interval T. Moreover the DC motor control unit 540 determines the speed of rotation of the DC motor 700 so that a speed of movement of the carriage 200 will be a speed of movement V that is slower than the assumed speed of movement W, and determined the driving voltage for the DC motor 700 so that the DC motor 700 will have that speed of rotation. For example, the DC motor control unit 540 determines the speed of rotation of the DC motor 700 so that the speed of movement V of the carriage 200 will about 90% of the speed of motion W, and determines the drive voltage for the DC motor 700 so that the DC motor 700 will have that speed of rotation.

Note that the DC motor control unit 540, as shown in FIG. 6, causes the carriage 200 to enter a standby state so that the head of the scan position will be adjacent to the scan start position in the scan direction (the x direction). (Step S30)

Furthermore, the DC motor control unit 540 determines whether or not there is a start scan instruction from the PC through the external interface unit 580 (in Step S40). If there is no start scan instruction (Step S40: No) the DC motor control unit 540 waits.

When there is a start scan instruction from the PC (Step S40: Yes), the DC motor control unit 540 drives the DC motor 700 at a drive voltage that will cause the speed of rotation that was determined in the process in Step 20.

Moreover, the ASIC 510 performs the scanning control process for every other line (Step S100).

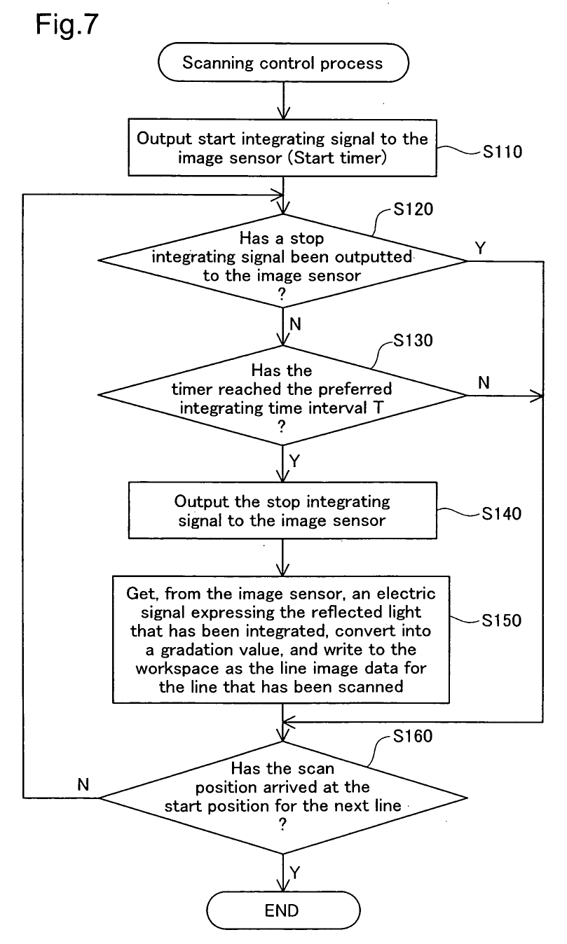

FIG. 7 is a flow chart illustrating the scanning control process in the present embodiment. Preconditions for this process are, as described above, the encoder control unit 530 detecting the encoder pulses that are outputted from the encoder 600 to detect the position of the carriage 200 relative to the scan start position in the scan direction.

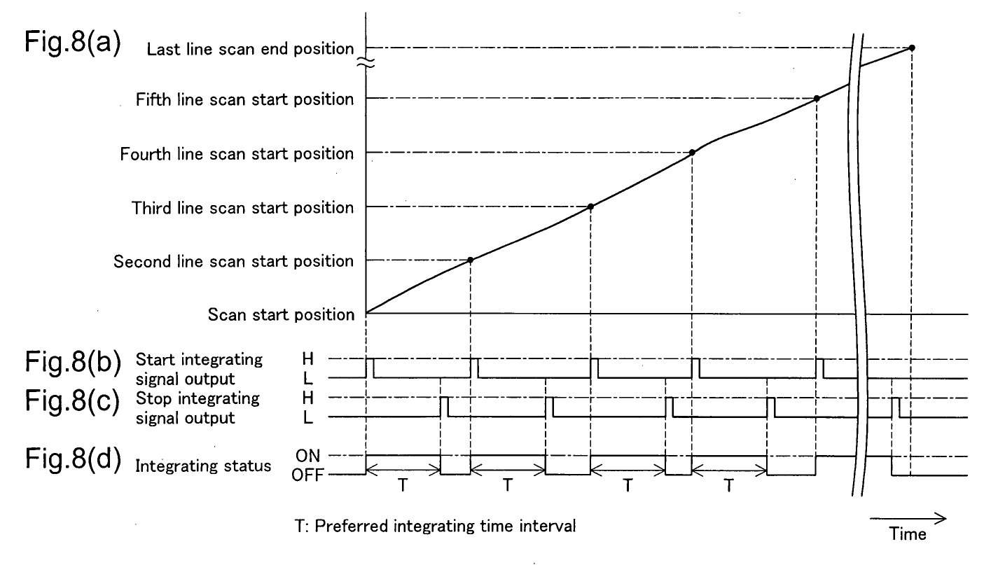

FIG. 8 is a figure showing the state wherein the image sensor control unit 520 controls the image sensor 220 in response to variations in the time interval at the scan position on the manuscript. The horizontal axis of each graph in FIG. 8 illustrates the time interval from the start of driving of the DC motor 700. The vertical axis in FIG. 8 (a) shows the position of the scan position that is formed by the carriage 200 on the manuscript, and the vertical axis in FIGS. 8 (b) and (c) show the outputted values of the start integrating signal and stop integrating signal that are outputted to the image sensor 220 by the image sensor control unit 520. In this case, the “H” indicates the state wherein the signal is outputted and “L” indicates the state wherein the image is not outputted. The vertical axis of FIG. 8 (d) shows the state of integrating of the reflected light in the image sensor 220. In this case, “ON” indicates the state wherein the reflected light is being integrated and “OFF” indicates the state wherein the integrating of the reflected light is stopped.

Note that the DC motor control unit 540 is such that the DC motor 700 is driven at a speed of rotation based on the driving voltage that is set by the process in Step S20, described above (Step S50), but the speed of rotation of the DC motor 700 may have some degree of variability in terms of the speed of rotation that has been set, due to tolerances, etc., in the speed of rotation. Accordingly, as is shown in FIG. 8 (a) the speed of motion of the carriage 200 will also have some degree of variability due to the rotational tolerances of the DC motor 700.

First, in the scanning control process (FIG. 7) for the first line (line 1), the image sensor control unit 520 outputs a start integrating signal, to the image sensor 220, as shown in FIG. 8 (b), when the DC motor 700 is started, to cause the image sensor 220 to start to integrate the light that is reflected from the scan position. At this time, the image sensor control unit 520 starts the timer 525 to start measuring the time (Step S110). The image sensor 220 starts integrating the reflected light when the start integrating signal is inputted from the image sensor control unit 520.

Next, the image sensor control unit 520 determines whether or not a stop integrating signal has been outputted to the image sensor 220 (Step S120). If, in the process in Step S140 that is described below, the image sensor control unit 520 has outputted a stop integrating signal to the image sensor 220 (Step 120: Yes), then control jumps to the process in Step S160.

If the image sensor control unit 520 has not outputted a stop integrating signal to the image sensor 220 (Step S120: No), then the timer 525 determines whether or not the preferred integrating time T has elapsed (Step S130).

The image sensor control unit 520 jumps to the process in Step S160 if the timer 525 has not reached the preferred integrating time T (Step S130: No).

If the timer 525 has reached the preferred integrating time T (Step S130: Yes), then next, as shown in FIG. 8 (c) the image sensor control unit 520 outputs the stop integrating signal to the image sensor 220, stopping the integrating of the reflected light in the image sensor 220 (Step S140). On the other hand, when the image sensor 220 inputs the stop integrating signal from the image sensor control unit 520, the integrating of the reflected light is stopped, and the reflected light that has been integrated is converted into an electric signal, which is outputted to the image sensor control unit 520.

The image sensor control unit 520 receives, from the image sensor 220, the electronic signal produced by the conversion of the reflected light that had been integrated, and then converts that electric signal into a gradation level. After this, the image sensor control unit 520 write the converted gradation level to the working space 577 as the line image data for the first line (Step S150). Note that this line image data is the image data corresponding to a range based on the y-direction range information. (See Step S10). The number of pixels of the line image data in the y direction is determined from the resolution based on the resolution information in the y direction. (See Step S10.)

Next, the encoder control unit 530 determined whether or not the scan position has arrived at the start position for the next line (Step S160). If the scan position has not arrived at the starting position of the next line (Step S160: No), the encoder control unit 530 returns to the process in Step S120 again.

If the scan position has arrived at the starting position for the next line (Step S160: Yes), then the encoder control unit 530 terminates the scanning control process (FIG. 7), and returns to the read-in process (FIG. 5).

Next, in the read-in process (FIG. 5), when the scanning control process has been completed, the image sensor control unit 520 determines whether or not the scanning control process (FIG. 7) has been completed for all lines in the scan region (Step S200).

The image sensor control unit 520 returns to the process in Step S100, and performs the scanning control process on the following line, if the scanning control process (FIG. 7) has not been completed for all of the lines in the scan region (Step S200: No).

Here, in the scanning control process (FIG. 7) for the second line and beyond, when the scan position arrives at the starting position of the applicable line, the image sensor control unit 520 outputs the start integrating signal to the image sensor 220, as shown in FIG. 8 (b) to start the image sensor 220 integrating the light that is reflected from the scan position, and the timer 525 is started to begin measuring the time (Step S110). Following this, the processes in Step S120 through Step S160 are performed in the same manner as described above. Note that in the process in Step S150, when the image sensor control unit 520 write the line image data for a line to the work area 577, an association with the line is written as well.

Given this, if the scanning control process (FIG. 7) has been completed for all of the lines in the scan region (Step S200: Yes) the image sensor control unit 520 stores the line image data, to which an association has been added for each line in the work area 577, into the image data storing unit 577 as image data in the scan region of the manuscript (Step S210). After this, the ASIC 510 ends the read-in process.

As described above, the scanner 100 according to the present embodiment outputs a start integrating signal (FIG. 8 (b)) to the image sensor 220 when the scan position has arrived at the scan start position of each line, to start the image sensor 220 integrating the reflected light, and after the preferred integrating time interval T has elapsed, a stop integrating signal is outputted to the image sensor 220 (FIG. 8 (c)) to stop the image sensor 220 integrating the reflected light. Following this, as shown in FIG. 8 (d) the image sensor 220 can integrate the reflected light, over the preferred integrating time interval T, over the time over which the scan position moves from the start position of the line to the start position of the next line, for each line. In doing this, in the image sensor 220, the integrating of the reflected light will not saturate, but rather it is possible to control the chromatic non-uniformities that occur between the lines of line image data that are each generated based on the reflected light that is integrated in each line, making it possible to generate each line image data with high accuracy.

Moreover, the scanner 100 in the present embodiment determines the drive voltage for the DC motor 700 in the read-in process (FIG. 5) so that the speed of motion or the carriage 200 (the scan position) will be slower than the speed of motion W (that is, the speed of motion when it is assumed that the line width n moves in the preferred integrating time interval T. Doing this makes it possible to move the carriage 200 (the scan position) at a speed that is slower than the motion at the speed of movement W, even when the speed of movement of the carriage 200 (the scan position) is faster than the speed of movement V because the speed of rotation of the DC motor 700 is faster than the speed of rotation corresponding to the driving voltage that has been determined, due to, for example, the tolerance in the speed of rotation, as shown in FIG. 8 (a). Consequently, it is possible to control the time interval over which the scan position moves from the scan start position in a line to the scan start position in the next line, for each line in the scan region, to be no more than the preferred integrating time interval T. In other words, in the scanning control process (FIG. 7) for each line, it is possible to control the integrating time for the reflected light in the image sensor 220 to be no more than the preferred integrating time interval T. The results is that it is able to prevent the occurrence of chromatic non-uniformities between the individual lines of line image data.

### B. Second Embodiment

B1. Structure of the Scanner

A second embodiment according to the present invention will be explained next. The outer appearance of the scanner 100 in the present embodiment is the same as the case in the first embodiment shown in FIG. 1, where overview of the structure in the scanner main unit 110 in the scanner 100 according to the present embodiment is also the same as the case in the first embodiment shown in FIG. 2, where the structure and functions of the carriage 200 in the present embodiment are also the same as those in the case of the first embodiment shown in FIG. 3, and the schematic structure of the control circuit 500 in the present embodiment is also the same as the case in the first embodiment shown in FIG. 4.

However, in the present embodiment, the encoder control unit 530 outputs a motor driving signal to the DC motor control unit 540 in the read-in process described below (the scanning control process) to cause the DC motor control unit 540 to drive the DC motor 700, and outputs a stop motor signal to the DC motor control unit 540 to cause the DC motor control unit 540 to stop the DC motor 700.

When the DC motor control unit 540 receives a motor control signal from the encoder control unit 530, the DC motor control unit 540 provides, to the DC motor 700, the direct current power that is outputted from the rectifier circuit 550 to drive the DC motor 70, and controls the voltage (the drive voltage) to control the speed of rotation of the DC motor 700. Moreover, when a stop motor signal is received from the encoder control unit 530, the DC motor control unit 540 stops providing, to the DC motor 700, the DC power that is outputted from the rectifier circuit 550, to thereby stop the driving of the DC motor 700. This DC motor control unit 540 corresponds to the “motor control unit” in the claims.

Note that the DC motor control unit 540 controls the driving voltage through performing pulse width modulation (PWM) control. That is, the DC motor control unit 540 turns a power control transistor (not shown) off and on with a prescribed switching interval (for example, 50 μS), and varies the ratio of the on interval to the total switching interval (that is, the duty ratio) depending on the drive voltage. In this way, the drive voltage is reduced through reducing the on time through reducing the duty ratio, and the drive voltage is increased by increasing the on time by increasing the duty ratio.

B2. Read-in Process

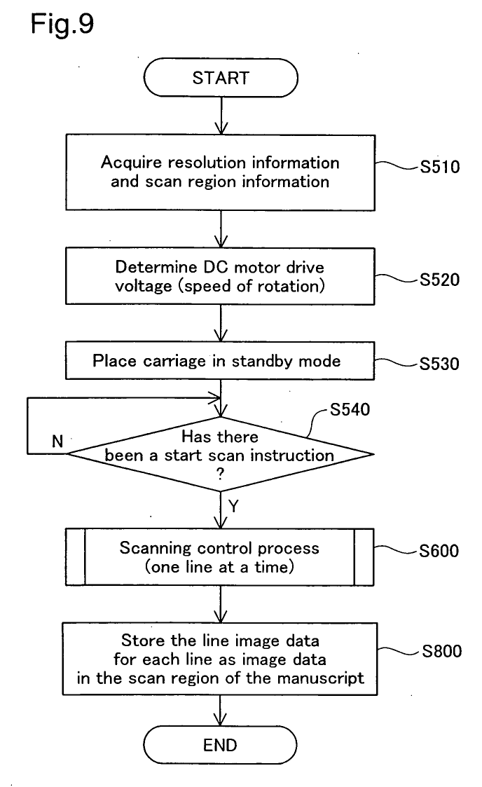

FIG. 9 is a flow chart illustrating the manuscript read-in process that is performed by the scanner 100 according to the present embodiment. Note that in the present embodiment the view of the manuscript from the carriage 200 is the same as in FIG. 6, described above. Given this, the read-in process whereby the image data for the manuscript is generated, by the scanner 100 (the ASIC 510) according to the present embodiment reading in the manuscript, will be explained below.

First, the ASIC 510 obtains from the CPU 560 the resolution information (the scan-direction resolution information and the resolution information in the y direction) and the manuscript scan region information (the scan direction length information and the y direction range information), which was sent from the PC (Step S510). After this, the encoder control unit 530 sets the number of equal lines, depending on density according to the scan direction resolution T, in the scan region in the scan direction, as shown in FIG. 6. Each line width n is determined by the scan-direction resolution P. Moreover, the number of lines Px is determined by the scan-direction length N, which expresses the scan-direction length information.

In the read-in process, the scanner 100 according to the present embodiment generates scan data for the manuscript by detecting the line scan data at each of the lines as the scan position, formed by the carriage 200 on the manuscript passes over each of the lines, and then combining together these line image data.

Following this, the DC motor control unit 540 sets the rotational speed for the DC motor 700 so that the carriage 200 will move in the scan direction (the x direction) at the speed of movement W and sets the drive voltage so that the DC motor 700 will have that speed of rotation (Step S520). At this time, the speed of movement W is the speed for the case where it is assumed that the carriage 200 will move the line width n over the preferred integrating time interval T. This drive voltage that has been set becomes the drive voltage with which the DC motor 700 is driven by the DC motor control unit 540 in the scanning control process described below.

Next the DC motor control unit 540 places the carriage 200 in a standby state so that the head of the scan position is adjacent to the scan start position in the scan direction (the x direction) as shown in FIG. 6 (Step S530).

Given this, the DC motor control unit 540 determines whether or not there has been a start scan instruction from the PC through the external interface unit 580 (Step S540). If there has been no start scan instruction (Step S540: No) then the DC motor control unit 540 waits.

If there is a start scan instruction from the PC (Step S540: Yes) then the DC motor control unit 540 performs the scanning control process described below (Step S600).

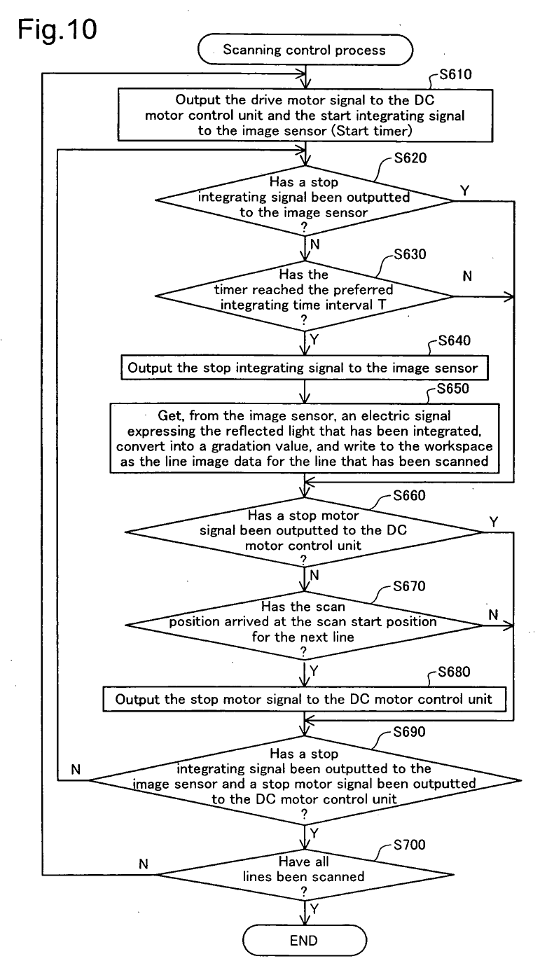

FIG. 10 is a flow chart illustrating the scanning control process in the present embodiment. The precondition for this process, as described above, is that the encoder control unit 530 detects the encoder pulses that are outputted from the encoder to detect the position of the carriage 200 in the scan direction in relation to the scan start position.

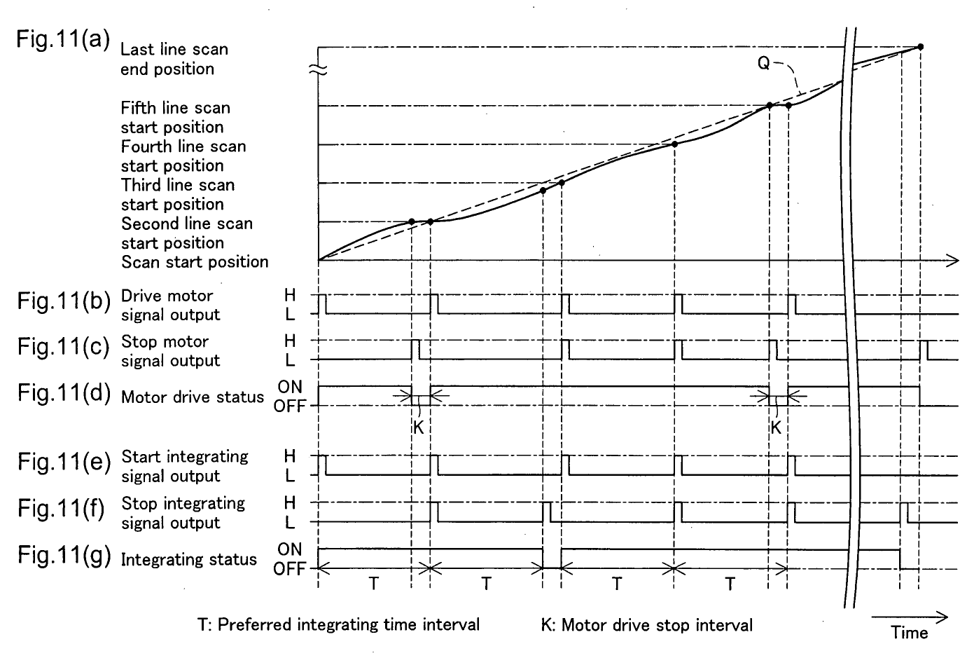

FIG. 11 is a figure illustrating the situation wherein the DC motor control unit 540 and the image sensor control unit 520 control the DC motor 70 and the image sensor 220 in response to variation in the time interval for the position of the scan position on the manuscript. The horizontal axis of each graph in FIG. 11 show the time after the start of driving the DC motor 700 after the carriage 200 has been set to the standby position. (See Step 530.) The vertical axis in FIG. 11 (a) shows the position of the scan position that is formed by the carriage 200 on the manuscript. The vertical axes in FIGS. 11 (b) and (c) show the output values of the drive motor signal and stop motor signal from the encoder control unit 530 to the DC motor control unit 540. In this case, “H” indicates a state wherein the signal is outputted, and “L” indicates the state wherein the signal is not outputted. The vertical axis of FIG. 11 (d) indicates the state of driving of the DC motor 700. In this case, “ON” indicates a state wherein the DC motor 700 is driven, and “OFF” indicates a state wherein the DC motor is not driven. “K” in the figure indicates the time at which the driving of the DC motor 700 is stopped (the motor drive stop interval). The vertical axes in FIGS. 11 (e) and (f) indicates the output value of the start integrating signal and the stop integrating signal that are outputted to the image sensor 220 from the image sensor control unit 520. The vertical axis in FIG. 11 (g) indicates the state of integrating of the reflected light in the image sensor 220. In this case, “ON” indicates the state wherein the reflected light is being integrated, and “OFF” indicates the state wherein the reflected light is not being integrated.

Note that when the DC motor control unit 540 drives the DC motor 700 based on the motor control signal, the DC motor 700 is driven at a speed of rotation based on the drive voltage set in the process in Step S520, described above, however, the speed of rotation of the DC motor 700 may vary somewhat from the set value for the speed of rotation due to rotational tolerances (rotational variations). Accordingly, as is shown in FIG. 11 (a), the speed of movement of the carriage 200 will also vary somewhat depending on the rotational tolerance (rotational variation) of the DC motor 700. Additionally, in FIG. 11 (a) the straight line queue, shown by the dotted line, indicates the speed of motion of the scan position when the DC motor is driven at the drive position that will have the speed of rotation that is set in the process in Step S520, when it is assumed that in the DC motor 700 there is no rotational tolerance (rotational variability) in the speed of rotation.

First, in the scanning control process (FIG. 10), when there is a start scan instruction from the PC (FIG. 9, Step S540: Yes), the encoder control unit 530 outputs the drive motor signal to the DC motor control unit 540, as shown in FIG. 11 (b), both starting the driving of the DC motor 700 by the DC motor control unit 540, and causing the image sensor control unit 520 to output the start integrating signal to the image sensor 220, as shown in FIG. 11 (e) to start the integrating of the light reflected from the scan position by the image sensor 220. Furthermore, in this case the image sensor control unit 520 starts the timer 525 to start the time measurement (Step S610). When the drive motor signal is inputted, the DC motor control unit 540 drives the DC motor 700 with a drive voltage so as to rotate at the speed of rotation determined in the process in Step S520. Accordingly, the scan position begins to move in the scan direction (the x direction) from the scan start position (FIG. 6). The image sensor 220 starts integrating the reflected light when the start integrating signal is inputted.

Next, the image sensor control unit 520 determines whether or not a stop integrating signal has been outputted to the image sensor 220 (Step S620). If a stop integrating signal has been outputted to the image sensor 220 in the process in Step S640, described below (Step S620: Yes), the image sensor control unit 520 jumps to the process in Step S660.

Note that if a stop integrating signal has been outputted to the image sensor 220 (Step S620: No), then the image sensor control unit 520 determines whether or not the timer 525 has reached the preferred integrating time interval T (Step S630).

If the timer 525 has not reached the preferred integrated time interval T (Step S630: No), the image sensor control unit 520 jumps to the process in Step S660.

If the timer 525 has reached the preferred integrating time interval T (Step S630: Yes), the image sensor control unit 520 then outputs a stop integrating signal to the image sensor 220, as shown in FIG. 11 (f) to stop the image sensor 220 from integrating the reflected light (Step S640). On the other hand, when the image sensor 220 inputs a stop integrating signal from the image sensor control unit 520, the integrating of the reflected light is stopped and the reflected light that has been integrated is converted into an electric signal, which is outputted to the image sensor control unit 520.

Following this, the image sensor control unit 520 receives the electric signal, produced by converting the reflected light that has been integrated, from the image sensor 220, and converts the signal into a gradation value. Moreover, the image sensor control unit 520 writes the converted gradation value, as the line image data for the first line, to the work area 577 (Step S650). Note that this line image data is image data corresponding to the range shown by the y direction range information. (See Step S510.) Moreover, the number of pixels in the y direction in the line image data is determined by the resolution based on the image resolution in the y direction. (See Step 510.)

Next, the encoder control unit 530 determines whether or not a stop driving signal has been outputted to the DC motor control unit 540 (Step S660). If, in the process in Step S680, described below, a stop motor signal has been outputted to the DC motor control unit 540 (Step S660: Yes), the encoder control unit 530 jumps to the process in Step S690, described below.

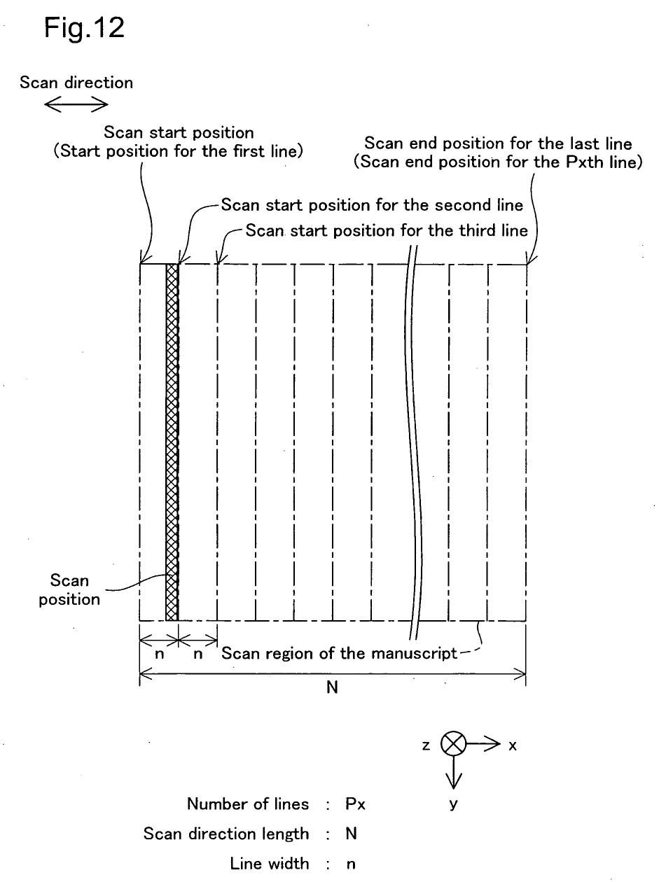

FIG. 12 is a figure showing the state when the scan position, shown in FIG. 6, has arrived at the scan start position of the second line. The figure shows the case wherein the scan position, which has passed over the first line, has reached the scan end position of the first line, or in other words, the scan start position for the second line. In this case, the “next line scan start position” when the scan position has passed over the line and arrived at the scan start position of the next line, refers to the head of the scan position being adjacent to the scan start position in the scan direction (the x direction).

Following this, if a stop motor signal has not been outputted to the DC motor control unit 540 (Step S660: No), the encoder control unit 530 determines whether or not the scan position has arrived at the scan start position (as shown in FIG. 12) of the next line (Step S670).

If the scan position has not arrived at the scan start position of the next line (Step S670: No), the encoder control unit 530 jumps to the process in Step S690.

If the scan position has arrived at the scan start position for the next line (Step S670: Yes), then the encoder control unit 530, as shown in FIG. 11 (c) outputs a stop motor signal to the DC motor control unit 540, causing the DC motor control unit 540 to stop driving the DC motor 700 (Step S680).

Following this, in the process in Step S690, the ASIC 510 determines whether or not the image sensor control unit 520 has outputted a stop integrating signal to the image sensor 220 and determines whether or not the encoder control unit 530 has outputted a stop motor signal to the DC motor control unit 540.

If the image sensor control unit 520 has not outputted a stop integrating signal to the image sensor 220 and the encoder control unit 530 has not outputted a stop motor signal to the DC motor control unit 540 (Step S690: No), then the ASIC 510 returns to the process in Step S620.

If the image sensor control unit 520 has outputted a stop integrating signal to the image sensor 220 and the encoder control unit 530 has outputted a stop motor signal to the DC motor control unit 540 (Step S690: Yes), the ASIC 510 determines whether or not all of the lines in the scan region have been completed, or in other words, whether or not processing has been completed through line Px (FIG. 6) (Step S700). The ASIC 510 returns to the process in Step S610 if scanning has not been completed for all lines within the scan region (Step S700: No).

The ASIC 510 performs the processes in Steps 610 through 690, described above, for the second line and beyond as well. Note that in this case, the encoder control unit 530 moves to the scan for the next line (Step S700: Yes) after outputting the stop motor signal in the process in the aforementioned Step 680, and then in such a case as if the drive motor signal was outputted in the process in Step S610 (shown in FIGS. 11 (b) and (c)), the DC motor control unit 540 does not stop driving the DC motor 700, but allows the motor to continue being driven as is. Moreover, in this type of case, the DC motor control unit 540 may instead stop driving the DC motor 700 temporarily following the input of the stop motor signal, and then restart driving the motor following the input of the drive motor signal.

The ASIC 510 ends the scanning control process and returns to the read-in process (FIG. 9) when scanning of all of the lines in the scan region has been completed (Step S700: Yes).

Moreover, when the scanning control process (FIG. 10) has been completed, the image sensor control unit 520 stores, in the image data storing unit 575, the line image data for each of the lines that have been read into the work area 577 in the read-in process (FIG. 9), doing so as the image data in the scan region of the manuscript (Step S800). After this, the ASIC 510 ends the read-in process.

As described above, in the scanning control process (FIG. 10) in the present embodiment, the scanner 100 outputs the drive data signal (FIG. 11 (b)) when, in each of the lines, the scan position arrives at the scan start position (FIG. 6) for that line, thereby driving the DC motor 700, and also outputs the start integrating signal (FIG. 11 (e)) to the image sensor 220 to start the image sensor 220 integrating the reflected light. Moreover, if the scan position has not yet arrived at the scan start position for the next line (FIG. 12) (Step S670: No) even though the preferred integrating time interval has already elapsed (Step S630: Yes), the scanner 100 outputs a stop integrating signal (FIG. 11 (f)) to the image sensor 220. On the other hand, if the scan position arrives at the scan start position for the next line (Step S670: Yes) even though the preferred integrating time interval T has not elapsed (Step S630: No), then the scanner 100, as shown in FIG. 11 (d) outputs a stop motor signal so as to stop driving the DC motor 700 for a motor drive stop time interval K. Consequently, as is shown in FIG. 11 (g), the image sensor 220 can, in each line, perform the integrating of the reflected light reliably over exactly the preferred integrating time interval T, during the interval over which the scan position moves from the scan start position for that line to the scan start position for the following line. The result is that, in the image sensor 220, the amount of the reflected light that is integrated will neither reach saturation nor be too little, making it possible to prevent chromatic non-uniformities between the line image data that are each generated based on the reflected light that is integrated in each line, making it possible to produce the line image data for each line with higher precision.

Moreover, in the scanning control process according to the present embodiment (FIG. 10) when, in each line, the scan position arrives at the scan start position for the line, the scanner 100 outputs a start integrating signal and a drive motor signal. In the scanner 100, after the stop integrating signal is outputted after the preferred integrating time interval T has elapsed after the outputting of the start integrating signal, and after the drive motor signal has been outputted, when the scan start position in the next line is reached, the stop motor signal is outputted. Moreover, in the scanner 100, the condition for outputting these signals are so as to start the scanning on the next line. Doing this makes it possible to start the image sensor 220 integrating the reflected light reliability during the preferred integrating time interval T, and makes it possible to move reliably from scanning one line to scanning the next line.

### C. Modified Example

Note that the present invention is not limited to the examples of embodiment described above, but rather can be embodied in a variety of forms without deviating from the spirit or intent thereof.

C1. Modified Example 1

In the scanning control process in the second embodiment described above (FIG. 10), if, after the scan position has moved from the line scan start position in any given line, the scan position has not yet arrived at the scan stop position (Step 670: No) even though the preferred integrating time interval T has already elapsed (Step S630: Yes), the scanner 100 causes the scan position to move as it is until the next scan start position is reached, and when this position is reached, the scanner 100 outputs the stop motor signal to the DC motor control unit 540. (See FIG. 11.) Moreover, in this case, even though the scanner 100 begins the scanning of the next line under the condition of the outputting of the stop motor signal (Step S690: Yes), the present invention is not limited thereto. For example, the scanner 100 may instead move the scan position as it is until it reaches the scan start position for the next line if, after the scan position has moved from the scan start position for a line the scan position still has not reached the scan start position for the next line (Step 670: No) even after the preferred integrating time interval T has elapsed (Step S630: Yes), and then may start scanning for the next line upon the condition of detecting the arrival at the scan start position for the next line.

C2. Modified Example 2

The scanner 100 in the embodiment described above applies the so-called optical scaling method as the method of reading in the manuscript; however, the present invention is not limited thereto. For example, the scanner 100 may use the contact image sensor method (CIS method) as the method for reading in the manuscript. In this case, the carriage may be integrated with an illumination light (not shown) that sequentially illuminates the manuscript with red, green, and blue light, a lens (not shown), and an image sensor (not shown) provided in tight contact with each other gathered together on rods of identical lengths.

C3. Modified Example 3

While the scanner 100 in the embodiment described above used a DC motor as the motor for driving the carriage 200, the present invention is not limited thereto. For example, the scanner 100 may instead use, as the motor for driving the carriage 200, an AC motor that is driven by an alternating current, a stepping motor, or a linear motor. When an AC motor or a stepping motor is used, the position of the carriage 200 is detected based on encoder pulses from the encoder 600, where the encoder 600 is connected in the same way as in the embodiment described above. Moreover, when a linear motor is used, a position sensor is provided instead of the encoder 600 to detect the position of the carriage 200.

C4. Modified Example 4

While in the embodiment described above, the image sensor control unit 520 outputs the start integrating signal and the stop integrating signal to the image sensor 220 to integrate the reflected light over the preferred integrating time interval T in the image sensor 220 for each line, the present invention is not limited thereto. For example, the scanner 100 may be provided with a shutter control unit (not shown) that drives a physical shutter at the light-incident surface of the image sensor 220. In this case, when the image sensor control unit 520 outputs the stop integrating signal to the shutter control unit, the shutter control unit closes the incident light surface of the image sensor 220 with a shutter, and when the image sensor control unit 520 outputs the start integrating signal to the shutter control unit, the shutter control unit exposes the incident light surface of the image sensor 220. This makes it possible to integrate the reflected light over the preferred integrating time interval T by the image sensor 220 for each line.

Moreover, the scanner 100 may be provided with a light control unit (not shown) for controlling the illumination of the light from the illumination light 205. In this case, when the image sensor control unit 520 outputs the stop integrating command to the light control unit, the light control unit stops the illumination of the light from the illumination light 205, and when the image sensor control unit 520 outputs the start integrating signal to the light control unit, the light control unit causes the light to be emitted from the illumination light 205. Doing this makes it possible to integrate the reflected light over the preferred integrating time interval T in the image sensor 220 for each line.

C5. Modified Example 5

In the read-in processing described above (FIG. 5 and FIG. 9), the scanner sets in advance a plurality of identical lines at a density, in the scan region in the scan direction, depending on the scan-direction resolution P in each line, where, when the scan position passes over the line, the scanning control process (FIG. 7 and FIG. 10) is performed; however, the present invention is not limited thereto. For example, the scanner 100 may be as described below. That is, the scanner 100 may perform a scanning control process over the interval wherein a scan position moves by the line thickness n that corresponds to the scan direction resolution P, from the scan start position (FIG. 6) (that is, moves one line) in a scan region, in the scan direction, where next the scanning control process may be performed during the interval wherein another line width n (that is, one line) is moved. The scanner 100 continues this type of process until the scan position arrives at the scan direction length N from the scan start position. In this way, the scanner 100 may set lines, one line at a time, from the scan start position, and may perform a scanning control process each time a line is set.

Note that as in the present modified example, the scanner 100 setting the scan start position one line at a time in the scan direction in the scan region effectively sets a plurality of identical lines in the entire scan region, where this is included in the concept in the claims of “setting a plurality of segments in the scan direction for the object to be scanned.”

C6. Modified Example 6

In the embodiment described above, for each part that is structured in software, the part instead may be structured in hardware, and each part that is structured in hardware, may instead be structured in software.

Finally the present application claims the priorities based on Japanese Patent Application No. 2005-206913 filed on Jul. 15, 2005 and Japanese Patent Application No. 2005-218204 filed on Jul. 28, 2005, which are herein incorporated by reference.

What is claimed is:

1. A scanner for generating image data by scanning a specific object to be scanned, comprising:
a motor;
a carriage that is driven by the motor to move, in the scan direction, a scan position in the object to be scanned;
an image sensor that integrates reflected light that occurs as a reflection from the scan position, and converts the integrated reflected light into specific image data, and outputs the image data;
an segment setting unit for setting a plurality of segments in the scanning direction in the object to be scanned; and
an image sensor control unit for controlling the image sensor, wherein
the image sensor control unit causes the image sensor to start the integrating of the reflected light that occurs from the scan position with the timing with which the scan position enters into the segment in each of the segments of the object to be scanned, when the scan position passes over each of the segments of the object to be scanned through the carriage moving, and thereafter, the image sensor control unit causes the image sensor to stop the integrating of the reflected light after a prescribed time interval has elapsed, and causes the integrated the reflected light to be converted by the image sensor and outputted as image data for the segment, along with controlling the image sensor so that the specific time interval is the same time interval in each segment.

2. The scanner in accordance with claim 1, further comprising:
a motor control unit for controlling the motor so that the speed of movement of the carriage is slower than the speed when the carriage is moved over the specific time interval over a distance corresponding to the segment.

3. The scanner in accordance with claim 1, wherein:
the specific time interval is the maximum integrating time interval for integrating the reflected lights so as to not saturate the amount of the reflected light that is integrated.

4. The scanner in accordance with claim 1, further comprising:
an image data generating unit for generating the image data that expresses the object to be scanned based on each of the image data for each of the segments in the object to be scanned.

5. The scanner in accordance with claim 1, wherein:
the motor is a DC motor that is driven by a direct current.

6. A scanner for generating image data by scanning a specific object to be scanned, comprising:
a motor;
a carriage that is driven by the motor to move, in the scan direction, a scan position in the object to be scanned;
an image sensor that integrates the reflected light that is produced by reflecting from the scan position, and converts the integrated reflected light into specific image data, and outputs the image data;
an image sensor control unit; and
a motor control unit, wherein
the image sensor control unit causes the image sensor to start the integrating of the reflected light that occurs at the scan position with the timing with which the scan position enters the start point of a segment, in each of the segments of the object to be scanned, when the scan position passes over each of the individual segments, due to the motion of the carriage, in the scan direction relative to the object to be scanned, and, thereafter, the image sensor control unit causes the image sensor to stop the integrating of the reflected light when a specific time interval, established in advance, has elapsed after the timing, after which the reflected light that has been integrated is converted by the image sensor and outputted as image data for the segment; wherein
the motor control unit causes the scan position to continue moving in the same way by causing the motor to continue moving the carriage in the same way when the scan position has not yet reached the end point of the segment even when the specific time interval has elapsed from the timing at which the scan position entered into the start point of the segment; and wherein
the motor control unit stops the motion of the scan position, through stopping the driving of the carriage by controlling the motor when the scan position has reached the end point of the segment even though the specific time interval has not yet elapsed after the timing, where, thereafter, the motor control unit causes the carriage to be driven, by controlling the motor, to start the movement of the scan position when the specific time interval has elapsed after the timing.

7. The scanner in accordance with claim 6, wherein:
the specific time interval is the maximum integrating time interval in order to integrate the reflected light without saturating the integrating of the reflected light.

8. The scanner in accordance with claims 6, further comprising:
an image data generating unit for generating the image data that expresses the object to be scanned, based on each image data in each of the segments of the object to be scanned.

9. The scanner in accordance with claim 6, wherein:
the motor is a DC motor that is driven by a direct current.

10. A method of controlling a scanner that generates image data by scanning a specific object to be scanned, wherein:
the scanner comprises:
a carriage that moves, in the scan direction, a scan position in the object to be scanned; and
an image sensor that integrates reflected light that occurs by reflecting from the scan position, converts, into specific image data, the reflected light that has been integrated, and outputs the image data; wherein
the scanner control method comprises the steps of:
(a) moving, in the scan direction, the scan position in the object to be scanned;
(b) setting a plurality of segments, in the scan direction, in the object to be scanned; and
(c) controlling the image sensor so as to cause the image sensor to start the integrating of the reflected light that occurs at the scan position with the timing with which the scan position enters into the segment, for each of the segments of the object to be scanned, when the scan position passes over each of the segments in the object to be scanned and, thereafter, after a specific time interval has elapsed, to cause the image sensor to stop the integrating of the reflected light, and then to convert, by the image sensor, the reflected light that has been integrated, and to not only output the results as image data for the segment, but to also cause the specific time to be the same for each segment.

11. A method of controlling a scanner that generates image data by scanning a specific object to be scanned, wherein:
the scanner comprises:
a carriage that moves, in the scan direction, a scan position in the object to be scanned; and
an image sensor that integrates reflected light that occurs by reflecting from the scan position, converts, into specific image data, the reflected light that has been integrated, and outputs the image data; wherein
the scanner control method comprises the steps of:
(a) causing the image sensor to start the integrating of the reflected light occurring from the scan position with the timing with which the scan position enters into the start point of the segment for each segment of the object to be scanned when the scan position passes over a plurality of segments, in the scan direction, of the object to be scanned, due to the movement of the carriage, and thereafter, causing the image sensor to stop the integrating of the reflected light when a specific time interval, set in advance, has elapsed after the timing, and then converting, by the image sensor, the reflected light that has been integrated, and outputting the results as image data for the segment; and
(b) causing the motion of the scan position to continue unchanged, by causing the motor to continue driving the carriage, when the scan position has not yet arrived at the end point of a segment even though the specific time interval has elapsed after the timing with which the scan position entered into the starting point of the segment, and stopping the movement of the scan position, through stopping the driving of the carriage, through controlling the motor when the scan position has already arrived at the end point of the segment even though the specific time interval has not yet elapsed after the timing, and then, after the specific time interval has elapsed after the timing, controlling the motor to drive the carriage to start the movement of the scan position.
